(19) United States
(12) Patent Application Publication
(10) Pub. No.: US 2010/0003488 A1
(43) Pub. Date: Jan. 7, 2010

(54) WOOD SHEET COMPRISING NANOPARTICLES

(76) Inventors: Hans-Joachim Danzer, Zug (CH); Oliver Frederik Klaeusler, Basel (CH)

Correspondence Address: GREER, BURNS & CRAIN, LTD., Suite 2500, 300 South Wacker Drive, Chicago, IL, 60606, US

(21) Appl. No.: 12/166,959

(22) Filed: Jul. 2, 2008

(51) Int. Cl. B32B 5/02; B32B 5/00; B32B 37/00; B05D 7/06

(52) U.S. Cl. 428/220; 427/180; 428/323; 156/60

(57) ABSTRACT

A wood sheet having a front surface, a back surface and a thickness including nanoparticles, wherein the nanoparticles are present on the front surface, the back surface and throughout the thickness.

### BACKGROUND

The invention pertains to a wood sheet, in particular a wood veneer, having front and back surfaces and a thickness comprising nanoparticles, wherein said nanoparticles are present on said front and back surfaces and throughout the thickness, and to a process for the manufacture of said wood sheet comprising treating said front and back surfaces and the thickness of a wood sheet with a nanofluid comprising said nanoparticles, wherein said nanofluid soaks said wood sheet. The invention also pertains to the use of said wood sheet and of wood products, said wood products comprising said wood sheet, in applications which require enhanced mechanical, physical, chemical and/or biological resistance.

Wooden species may exhibit desirable characteristics with regard to mechanical, physical, chemical and/or biological resistance. However, by far, not all wooden species exhibit one or more of these desired characteristics, and/or are too costive, and/or are of limited availability for application, e.g. for application in the wood processing industry.

Surface treatments of wooden materials such as impregnation or coating in order to add properties not naturally occurring in wooden species of choice are already known. Prior art in this field focuses on adding one or a combination of characteristics to wooden material such as improved mechanical, physical, chemical and/or biological characteristics.

U.S. Pat. No. 5,652,065 discloses wood veneers having enhanced strength and/or stiffness wherein in the compacted wood cells of the veneer a cured rigid thermoset material, which maintains compaction of the compacted cells is interspersed. The preferred thermoset material is polyurea that is formed from a polyisocyanate resin applied to at least one major surface of the veneer followed by hot-pressing the veneer.

U.S. Pat. No. 3,076,738 suggests to utilize a resin for impregnating woody material which will increase the density, strength, waterproof character and bonding affinity of the material. The woody material can be a wood veneer or hardboard or a combination of wood veneer and hardboard. The resin is melamine aldehyde resin and sulfite dissolved in an aqueous solvent including at least about 40% as much alcohol as water by weight.

US 2002/0148051 A1 suggests to suppress changes in color of the wooden material caused by exposure to light or heat by subjecting a wooden material to a bleaching treatment and to an acetylating treatment. For example, a bleaching solution is applied onto the wooden material by means of a brush coating method or the like, and then the wooden material is treated for a predetermined time, for example, by soaking the wooden material in a bleaching solution for a predetermined time, while heating it as necessary. Specific examples of the bleaching solution include solutions such as hydrogen peroxide solution, a solution including chloride or hydrochloride. Specific examples of the wooden material include veneer produced by slicing wood, plywood, wood fiber board, particle board, solid materials, material combinations thereof, a composite material including a veneer on which aluminum or the like is attached, and the like.

U.S. Pat. No. 5,512,323 discloses a wood treatment process to reduce or eliminate grain raising associated with the application of water-based wood finishing compositions. The method comprises the step of wetting the wood surface with an aqueous solution of an aluminum salt, and preferably drying the surface prior to applying the water-based finish composition.

U.S. Pat. No. 4,145,242 relates to the treating of wood surfaces with a solution of selected boron compounds in order to preserve bondability during drying or storing. The compounds are applied in an aqueous solution to the wood surface prior to drying or storing. Wood products are such as bonded laminated lumber and particle board. Due to the treatment, the mechanical and physical properties of the wood products are improved, wherein the wood is also protected against decay and fungal attack.

U.S. Pat. No. 5,683,820 discloses wood products which are impregnated with a polymerizable monomer selected from the group consisting of hexanediol diacrylate and hexanediol dimethacrylate which have an excellent indent resistance. The thus treated hardened, fire-retardant wood product is for application such as flooring where uniform hardness is desirable.

U.S. Pat. No. 6,916,507 discloses methods for imparting dimensional stability and water repellence to substrates, for example, paper items, fibrous items and building materials such as wood and brick. Typically, materials are coated or impregnated with solutions of silicone compounds, acrylic, urethane, ester, fatty and oily resins or monomers, followed by drying. In particular, silicone water repellents of the solvent dilution type are used. Preferably, the silicone compounds are amino group-containing alkoxysilanes. Using the aqueous water repellent, the method can render plywood or laminated veneer lumber termite-proof, rot-proof, mildew-proof, water resistant, moisture resistant and dimensional stable.

US 2005/0255251 A1 discloses a method of preserving wood comprising injecting into wood nanoparticles selected from copper salts, nickel salts, tin salts and/or zinc salts.

US 2006/0063911 A1 discloses a film forming composition comprising nanoparticles, a resin, a surface active material and a polymeric dispersant. The film forming composition may be used with wood objects including furniture, doors and floors to enhance scratch resistance.

US 2006/0235145 A1 discloses nanosized silica, titanium oxide and zinc oxide compounded materials for surface modification of wood wall to improve chemical stability, resistance, and the capacity to repel and disperse water, oil, bacteria, organic dust, gas, electricity, magnetism and light (i.e., multi-phobic effects). For application, the nanosized material is sprayed onto the body surface.

Additional to said referenced application of nanoparticles, further applications of nanoparticles are known, for example applications in the field of textiles.

The methods for adding the above addressed characteristics to wooden surfaces as disclosed in the prior art necessarily change the natural optical and tactile characteristics of the wood or the wooden surface such as appearance, color, feel, reflection, structure, smell. Further, the characteristic changes achieved by the methods and products of the prior art are limited to the surface layers of the wooden material and cannot be maintained through further processing of the wooden material.

### SUMMARY

The problem to be solved by the present invention was to provide an improved wooden surface, in particular a wood sheet having enhanced mechanical or physical or chemical or biological resistance, or combinations of said resistances. In particular, water and oil repellence of the wood sheet, i.e. hydrophobicity and oliophobicity, should be improved.

The problem was solved by a wooden surface, in particular by a wood sheet having a front surface, a back surface and a thickness comprising nanoparticles, characterized in that said nanoparticles are present on said front surface, said back surface and throughout the thickness.

The wooden surface according to the invention maintains the addressed improved characteristics even during the further processing. For example, a mechanical treatment by sanding a wooden surface, which is equipped with a lacquer or a varnish in order to protect the surface against water reduces the protection characteristics, whereas sanding the wooden surface according to the invention maintains the addressed characteristics. Lacquers and varnishes in general are also unstable against UV radiation or against weather and /or atmospheric conditions, whereas the wooden surface according to the invention has an excellent resistance against UV radiation and weather and /or atmospheric conditions. Thus, advantageously, the wooden surface according to the invention has an extended durability over the wooden surfaces of the discussed prior art. A particular advantage of the wooden surface according to the invention is that said wooden surface after treatment with nanoparticles still maintains the natural optical and tactile characteristics of the employed wood. By contrast, the treatment of wooden surfaces as discussed in the prior art results in a disadvantageous change of the natural appearance of the employed wood. The addressed advantages of the wooden surface of the invention over the wooden surfaces of the prior art were neither foreseeable nor could be expected.

Specifically, the invention pertains to a wood sheet having a front surface, a back surface and a thickness comprising nanoparticles, characterized in that said nanoparticles are present on said front surface, said back surface and throughout the thickness, so as to confer enhanced mechanical or physical or chemical or biological resistance, or combinations of said resistances, to said wood sheet compared to an otherwise similar wood sheet that has no nanoparticles on its front and back surfaces and throughout its thickness.

### DETAILED DESCRIPTION

The term “enhanced mechanical resistance” comprises an enhanced stiffness, rigidity and scratch resistance.

The term “enhanced physical resistance” comprises enhanced repelling properties against water, oils and fats, dust and dirt. In particular, said physical resistance is an enhanced hydrophobicity and oliophobicity.

The term “enhanced chemical resistance” comprises an enhanced resistance against all solids, fluids, gases and radiation which may cause a damage or an adverse alteration of the wood surface, e.g. an alteration caused by acids; bases; oxygen, particularly oxygen in combination with heat; radiation, in particular UV radiation.

The term “enhanced biological resistance” comprises an enhanced resistance against microorganisms and creatures which digest wood, i.e. which can destroy the wood surface and/or which may cause a fouling of the wood, for example microorganisms such as bacteria and fungi, or termites.

In a preferred embodiment, the wood sheet is a veneer.

The term “veneer” means a ply of natural wood obtained from a log or other unit of natural lumber by any suitable means. These means include slicing or peeling a log or another unit of natural lumber. The term “slicing” includes means such as flat cut, true quarter, bastard quarter, flat quarter and rift cut. The term “peeling” includes stay log-half, peeled and peeled-out of center. These processes are known in the art. Veneers that can be applied for the invention can be manufactured according to processes which are disclosed and referenced, for example, in EP 1 688 228. There are no limits to the tree's pieces from which the veneer is obtained. Non-limiting examples of wood comprise hard wood, such as sapele and amazakoue, and soft wood, such as walnut, spruce.

As can be readily appreciated, a sheet or a veneer has a front and a back surface, that is the observe and reverse surface across which extend the length and width dimensions of the veneer. The thickness dimension extends between the perpendicular to the front and back surface.

The permissible thickness range of a sheet can vary depending upon the species of tree from which it was obtained, the intended use of the sheet, and other factors. In general, the thickness can vary between 0.1 mm and some centimeters, e.g. up to 5 cm.

Veneers can be very thin, such as 0.5 mm or less, and can approach, in certain instances, about 2.5 cm in thickness. Generally, however, a veneer tends to be thin in the thickness dimension relative to one or both the length and width dimensions. From a practical standpoint, most veneers tend to have a thickness of 6 mm or less. In general, thinner veneers (such as 6 mm or less) are more practical within most species of wood.

Preferably, the thickness of the wood sheet or wood veneer is from 0.1 mm to 10 mm, more preferred from 0.2 mm to 6 mm, still more preferred from 0.5 mm to 3 mm.

According to the invention, the nanoparticles are not only present on the front and back surface of the wood sheet, but also throughout the thickness or the thickness dimension, i.e. throughout the dimension which extends perpendicular between the front and back surface of the sheet, in particular of the veneer.

The term “nanoparticle” includes terms such as nanopowder, nanocluster, and nanocrytal particle with at least one dimension less than 100 nm, preferably below 50 nm, more preferred below 30 nm.

Methods for producing nanoparticles are state of the art. In one approach, nanoparticles can be prepared by physical gas-phase condensation which involves the evaporation of a source material and the rapid condensation of vapour into nanometer-sized crystallites. Another manufacturing method is based on a chemistry-based solution-spray conversion process, that starts with water-soluble salts of source materials. The solution is then turned into an aerosol and dried by a spray-drying system. Rapid vaporization of the solvent and rapid precipitation of the solute keeps the composition identical to that of the starting solution. A third technique is to generate nanophase materials by condensation of metal vapours during rapid expansion in a supersonic nozzle.

Also attrition and pyrolysis are common methods. In attrition, macro or micro scale particles are ground in a ball mill, a planetary mill other size reducing mechanism. The resulting particles are air classified to recover nanoparticles.

In pyrolysis, an organic precursor (liquid or gas) is forced through an orifice at high pressure and burned. The resulting ash is air classified to recover oxide nanoparticle.

A thermal plasma can also deliver the energy necessary to cause evaporation of small micrometer size particles. The thermal plasma temperatures are in the order of 10000 K, so that solid powder easily evaporates. Nanoparticles are formed upon cooling while exiting the plasma region. The main types of the thermal plasma torches used to produce nanoparticles are dc plasma jet, dc arc plasma and radio frequency (RF) induction plasmas. In the arc plasma reactors, the energy necessary for evaporation and reaction is provided by an electric arc which forms between the anode and the cathode. For example, silica sand can be vaporized with an arc plasma at atmospheric pressure. The resulting mixture of plasma gas and silica vapour can be rapidly cooled by quenching with oxygen, thus ensuring the quality of the fumed silica produced. In RF induction plasma torches, energy coupling to the plasma is accomplished through the electromagnetic field generated by the induction coil. The plasma gas does not come in contact with electrodes, thus eliminating possible sources of contamination and allowing the operation of such plasma torches with a wide range of gases including inert, reducing, oxidizing and other corrosive atmospheres. The working frequency is typically between 200 kHz and 40 MHz. Laboratory units run at power levels in the order of 30-50 kW while the large scale industrial units have been tested at power levels up to 1 MW. As the residence time of the injected feed droplets in the plasma is very short it is important that the droplet sizes are small enough in order to obtain complete evaporation. The RF plasma method has been used to synthesize different nanoparticle materials, for example synthesis of various ceramic nanoparticles such as oxides, carbides and nitrides of Ti and Si.

Inert-gas aggregation is frequently used to make nanoparticles from metals with low melting points. The metal is vaporized in a vacuum chamber and then supercooled with an inert gas stream. The supercooled metal vapor condenses in to nanometer-sized particles, which can be entrained in the inert gas stream and deposited on a substrate or into a liquid.

Preferably, said nanoparticles used in the present invention are selected from the group consisting of carbon-based compounds, metals, metal oxides, and metal salts.

Carbon-based compounds are compounds such as carbon or organic pigments.

Metals are metals such as gold, silver, copper, nickel, and iron, silicon, aluminum, titanium, zinc, boron, ceria, zirconium, tin, antimony, indium, magnesium, calcium, or combinations thereof.

Metal oxides are oxides of the before-mentioned metals, such as silica, titanium oxide, aluminum oxide, iron oxide, zinc oxide, boron oxide.

Metal salts are salts of the above mentioned metals, such as copper salts, nickel salts, tin salts and/or zinc salts, such as copper chloride, iron chloride, zinc chloride.

Said nanoparticles may also comprise further compounds that are applied to the surfaces thereof. By means of said further compounds it is possible to confer to and enhance specific resistances of the wood sheet with regard to mechanical, physical, chemical and/or biological resistances.

Further compounds are for example derivatives of silica.

Preferred derivatives of silica are silazanes and silanes such as siloxanes and polysiloxanes, e.g. alkoxysilanes and poly(alkoxysilanes).

Particularly preferred silanes, siloxanes and polysiloxanes or alkoxysilanes and poly(alkoxysilanes) comprise one or more amino groups.

For example, said silica derivative can be an amino group-containing alkoxysilane. Such compounds are known from the prior art, for example from U.S. Pat. No. 6,916,507.

Nanofluids comprising nanoparticies comprising amino group-containing silanes are particularly preferred.

The nanoparticles may also comprise compounds such as fluorocarbons or fluoropolymers. These fluoro compounds typically comprise one or more fluorochemical radicals that contain a perfluorinated carbon chain having from 3 to about 20 carbon atoms, more preferably from about 6 to about 14 carbon atoms. These fluorochemical radicals can contain straight chain, branched chain, or cyclic fluorinated carbon, or any combination thereof. The fluorochemical radicals can optionally contain heteroatoms such as oxygen, sulfur, or nitrogen. Fully fluorinated radicals are preferred, but hydrogen or chlorine atoms may also be present as substituents. It is additionally preferred that any fluorochemical radical contain from about 40% to about 80% fluorine by weight, and more preferably, from about 50% to about 78% fluorine by weight.

Nanoparticles loaded with silicon compounds such as amino group-containing alkoxysilane and fluorocarbons are particularly preferred if hydrophobicity and/or oleophobicity are to be enhanced.

It is further possible to adsorb polymers on the surface of the nanoparticles, such as acrylates, styrene-based polymers, polybutadiene-based polymers, polyesters, polyurethanes, polyamides, and the like.

The nanoparticles employed in the present invention may also comprise bioactive or antimicrobial/fungal agents, sunblock agents, fire retardant chemicals, metallic reflector colloids, reflective particles, magnetic particles, insect repellants and/or fragrances.

The quantity of said nanoparticles being present on the front and the back surfaces and throughout the thickness of said wood sheet according to the invention preferably is from 0.5 g nanoparticles/m² wood sheet to 20 g nanoparticles/m² wood sheet, preferably from 1 g/m² to 15 g/m², more preferred from 2 g/m² to 10 g/m².

The process for the manufacture of a wood sheet having a front surface, a back surface and a thickness comprising particles, wherein said nanoparticles are present on said front surface, said back surface and throughout the thickness, comprises: treating the front and back surfaces and the thickness dimension of a wood sheet with a nanofluid comprising nanoparticles, wherein said nanofluid soaks said wood sheet.

The term “nanofluid” relates to fluids comprising nanoparticles. If nanoparticles are suspended in conventional fluids, such as organic fluids or water, a nanofluid is produced. The noble properties of nanophase materials come from the relatively high surface-area-to-volume ratio that is due to the high proportion of constituent atoms residing at the grain boundaries.

Methods for producing nanofluids are state of the art. Two techniques are frequently used to make nanofluids: the single-step direct vaporation method, which simultaneously makes and disperses the nanoparticles directly into the base fluids, and the two-step method which first makes nanoparticles and then disperses them into the base fluids. For nanofluids prepared by the two-step method, dispersion techniques such as high shear and ultrasound can be used to create various particle/fluid combinations. In general, the nanoparticles are dispersed in the base fluid in a concentration less than 20% by weight, preferably less than 15% by weight, more preferred less than 10% by weight.

Preferably, the base fluid of the nanofluid is water.

For stabilizing the dispersion, the nanofluid may contain the stabilizers and/or surfactants for dispersions known in the art.

Such stabilizers and/or surfactants may be selected from monomers, oligomers and polymers of anhydrides, such as maleic anhydride and esters thereof, glycols, such as ethylene glycol and polyethylene glycols, polyvinyl compounds, such as polyvinyl alcohol, polyvinyl acetate and polyvinyl pyrrolidone, modified celluloses, such as methyl cellulose and hydroxyethyl cellulose, phenols, such as nonyl phenol, carboxylates, such as sodium octyl succinate, dimethyformamide, N-methyl-pyrrolidone, and the like.

Alcohols such as short chain alcohols, such as methyl alcohol, ethyl alcohol, propyl alcohols and butyl alcohols, and long-chain alcohols, such as dodecyl alcohol and tridecyl alcohol, may also be added.

The term “treating” means that said nanofluid soaks said wood sheet, that is the nanofluid is allowed to penetrate through the front surface via the thickness dimension through the back surface, or vice versa, or through the front and back surface throughout the thickness dimension of the sheet, thereby completely wetting the wood sheet.

The nanofluid can be applied either on one surface of the wood sheet or on both surfaces provided that the nanofluid soaks the sheet in order allow the nanofluid to penetrate the sheet throughout the thickness dimension.

The presence of the nanoparticles on the front and back surface and throughout the thickness can basically be evidenced by methods such as Scanning Electron Microscopy (SEM) having a resolution from about 1-3 nm, Energy Dispersive X-Ray Spectroscopy in combination with SEM (SEM-EDX) having a resolution from about 2-3 nm, Environmental Scanning Electron Microscopy (ESEM) having a resolution from about 20-50 nm, Transmission Electron Microscopy (TEM) having a resolution from about 0.25-2 nm, Scanning Tunneling Microscopy (STM) and/or Atomic Force Microscopy (AFM). These methods are well known in the art.

The treating by soaking can be achieved by processes that are known in the art, for example by application of the nanofluid by a spraying process, by the application of the nanofluid by means of a brush, by dunking the wood veneer into the nanofluid, by applying the nanofluid by means of rollers. In each case, the soaking can be enhanced by means of pressure, such as incubation.

The nanofluid can be applied either on one surface of the wood sheet or on both surfaces provided that the nanofluid soaks the sheet.

Wood comprises wood fibers. The term “wood fibers” as used herein means cellulose elements and/or lignocellulose-origin material or the like of trees. Then, both the wood fibers of the front and back surfaces and throughout the thickness are soaked in the process of the invention. Without wishing to be bound to a theory, it is believed, if nanoparticles comprising amino-group-containing silane is used, said amino group-containing silane reacts via its amino group with hydroxyl groups of the lignocellulose-origin material, thus producing a covalent bond between the nanoparticle and the wood fiber of the wood sheet to result in the wood product having enhanced properties. However, it is also possible that the nanoparticles are bound via non-covalent interaction, e.g. via van-der-Waals interaction.

The wood sheet produced in the process of the invention is very stable with regard to thickness, length and width dimensions, i.e. the dimensions will in general not be altered or only negligibly altered during the manufacturing process.

If necessary, the wood sheet can be cut to size to produce e.g. a veneer. In a subsequent step, the sheets or sheets of veneer which were cut to size, can be joined by an adhesive. Suitable adhesives are two-component polyurethane adhesives or adhesives based on polyurea.

It is also possible to join wood sheets by means of the above adhesives prior to the treating with a nanofluid. In general, the already joined sheets will resist the treatment duration and the treatment temperature.

For example, a surface having a width and length of approximately 50 cm and a thickness of 1 mm can be soaked by the nanofluid within a process time between 10 to 300 minutes.

The soaking temperature in general is between 20° C. and 60° C., preferably 30° C. to 50° C.

However, the skilled person will readily appreciate that different process times and soaking temperatures will be necessary depending on the type of wood, the thickness dimension, the type of nanofluid and/or type of nanoparticle used.

If necessary, the soaked wood sheet can be dried in order to obtain a dry sheet which can be sold or which can be further processed. The drying methods known in the common manufacturing processes for veneers may be applied.

Further process steps may include the sanding of the back and/or the front surfaces or the polishing of said surfaces.

If the one or both surfaces of the wood sheet are further processed by sanding or polishing, the properties imparted by the nanoparticles are not affected but, to the contrary, are maintained. This advantageously distinguishes the wood sheet from wood products of the prior art where only the surface but not the thickness dimension has been treated with nanofluids. Here, sanding and polishing may result in a loss of the properties imparted by the nanofluids due to the removal of the part of the wood surface where the nanoparticles were present.

If desired, it is also possible to apply a varnish onto the surface of the sheets having nanoparticles. For example, an epoxy-based varnish can be applied to further improve e.g. the mechanical resistance such as the scratch resistance. However, in general, this will not be necessary due to the advantageous properties imparted by the nanoparticles. A protecting step as necessary for the wood surfaces of the prior art by application of a varnish or coating can be omitted.

If the surface of the sheet is not further treated with a coating, such as a varnish, the surface feel of the new wood surface will remain warm and soft with tactile surface structure. Advantageously, the natural appearance of wood can be maintained with such a sheet, further distinguishing the new wood surface from wood surfaces of the prior art that have been treated with a coating.

It has been proven that the moisture content of a wood sheet prior to the treating with a nanofluid may affect the quality of the resulting wood sheet.

In general, the quality is enhanced, if the moisture content of said wood sheet prior to the treating with a nanofluid is below the fiber saturation point (f.s.p.). Said fiber saturation point defines the point in a drying process of wood where said wood predominantly contains no “free” water, however, only “bonded” water. “Free” water is in the cell cavities of the wood and “bonded” water is in the cell walls of the wood. The moisture content is determined according to DIN 52183. Other determination methods may also be used, such as electrical methods (measurement of the Ohmic resistance) or the determination via reflection of infrared radiation. However, it is advisable to use the above DIN-method as a calibration method in order to obtain comparable values.

Accordingly, in a preferred embodiment of the process of the invention, the moisture content of said wood sheet prior to the treating with a nanofluid is below the fiber saturation point.

In general, the fiber saturation point is below 40%, preferably below 35%, more preferred below 32%.

As used herein, a “treated sheet” is a sheet that has been treated according to the process of the invention so as to confer enhanced mechanical or physical or chemical or biological resistance, or combinations of said resistances, to said wood sheet compared to an otherwise similar wood sheet that has not been treated with said nanofluid.

In one embodiment the invention pertains to a wood sheet having a front surface and a back surface and a thickness comprising nanoparticles, wherein said nanoparticles are present on said front surface, said back surface and throughout the thickness, preparable by a process, the process comprising: treating said front and back surfaces and the thickness of a wood sheet with a nanofluid comprising nanoparticles, wherein said nanofluid soaks said wood sheet.

The invention also pertains to a wood product, the wood product comprising a wood sheet having a front surface, a back surface and a thickness comprising nanoparticles, wherein said nanoparticles are present on said front surface, said back surface and throughout the thickness, and a substrate.

Substrates may be selected from the group consisting of wood, plywood, laminated fiber sheet, plastic, metal, such as aluminum, or stone.

Thus, it is possible to provide a wood product, wherein the substrate can be selected from a relatively cheap material, which is improved or ennobled with the high-grade wood sheet of the invention.

Such a wood product is manufactured by a process wherein the wood sheet of the invention is fixed onto said substrate. Preferably, it is glued onto said substrate by means of an adhesive.

Preferably, two component polyurethane systems can be applied as adhesive.

The invention also pertains to the use of the sheet and of the wood product comprising said sheet and said substrate.

Said sheet and said wood product comprising said sheet and a substrate may be used in all applications, where enhanced mechanical or physical or chemical or biological resistance, or combinations of said resistances, are required. Such applications comprise both outdoor and indoor applications, where a wood surface is subjected to humidity, moisture, oil, dirt, bacteria, UV radiation, microorganisms, mechanical stress, and the like.

The wood sheet comprising nanoparticles based on amino group-containing silanes has excellent repellent properties. Dirt, bacteria, fungi, and water as well as liquids based on oil are prevented from penetrating into said surface. Therefore, the surface of the sheet will maintain a clean appearance.

In particular, the wood sheet having a front surface, a back surface and a thickness comprising nanoparticies, characterized in that said nanoparticles are present on said front surface, said back surface and throughout the thickness, wherein the nanoparticles are based on amino group-containing silanes, has an enhanced hydrophobicity and oliophobicity as compared to an otherwise similar wood sheet that has not been treated with a nanofluid comprising said amino group-containing silane.

The sheets comprising nanoparticles in general have an excellent stability against UV radiation, i.e. surface structure and color of the sheet will be maintained over a period of many years.

Preferably, the wood sheet and the wood product comprising said sheet and a substrate can be used for the equipment of bathrooms, wellness installations, clinical practice equipments, equipment in yachting, equipment for restaurants.

Said equipment of bath rooms preferably is selected from the group consisting of walls, floors, wash basins, showers, bath tubs.

Said wellness installations preferably are selected from the group consisting of swimming pools and saunas.

Said clinical practice equipments preferably are selected from all surfaces to be easily and hygienically cleaned.

Said equipment in yachting preferably is selected from the group consisting of decks and body fairing.

Said equipment of restaurants preferably is selected from the group consisting of tables and bars.

The present invention, for the first time, achieves the optimization of a wooden material at the raw material production level, as opposed to the finished product level as disclosed in the prior art. The present invention, for the first time, allows the raw material consumer to choose the wooden specie that best suits the demands of the product's manufacture and end use, while simultaneously allowing the supplementing of a choice of one or many desirable wood characteristics of different wood species. The present invention therefore, increases opportunities for wooden applications, for species applications, and natural resource optimisation. The compositional change of the wooden material as achieved by the present invention allows almost all manners of further processing (i.e. sanding, cutting, joining) without changing either the enhanced or the natural properties of the wooden material. Selective characteristic combinations also permit further treatments such as varnishing or staining according to the consumer's plan for further manufacturing.

In a particularly preferred embodiment of the invention, the veneer employed in the process of the invention is manufactured according to the process as described in EP 1 688 228 B1. Such veneers are commercially available and are sold under the trademark Vinterio® such as Vinterio Stratus® and Vinterio Nimbus®. The use of such veneers as the starting material in the process of the invention allows the manufacture of particularly advantageous wood veneers comprising nanoparticles. Since, contrary to the other known methods of the prior art for producing veneers, the process for the manufacture of Vinterio® veneers maintains the natural appearance of the thus produced veneers, the process of the present invention preserves this natural appearance. Said natural appearance, depending on the used nanofluid and the type of nanoparticles dispersed therein, is also preserved under exposure to environmental impacts, such as mechanical stress; influence of water, oils and fats, dust and dirt; influence of acids, bases, oxygen, particularly oxygen in combination with heat, radiation, in particular UV radiation; influence of microorganisms and creatures which digest wood, i.e. which can destroy wood surfaces and/or which may cause fouling of wood, for example microorganisms such as bacteria and fungi, or termites.

EP 1 688 228 claims a process for the manufacture of a veneer in the form of a sheet which is composed of slices from board-like, plane pieces of wood wherein said slices are jointly adhered by means of an adhesive, the process comprising steps (i) to (iv):
(i) gluing board-like, plane pieces of wood holohedrally by means of an adhesive to a beam-like block of wood,
(ii) watering said beam-like block of wood obtained in step (i),
(iii) cutting said beam-like block of wood obtained in step (ii) such that the section plane is transversely arranged to the plane which is defined by the adhesion layers in said block to obtain said veneer,
(iv) drying said veneer obtained in step (iii) until the moisture content is below the fiber saturation point.

Accordingly, in a particularly preferred embodiment, the wood sheet comprising nanoparticles of the present invention is obtainable by a process comprising steps (i) to (v):
(i) gluing board-like, plane pieces of wood holohedrally by means of an adhesive to a beam-like block of wood,
(ii) watering said beam-like block of wood obtained in step (i),
(iii) cutting said beam-like block of wood obtained in step (ii) such that the section plane is transversely arranged to the plane which is defined by the adhesion layers in said block to obtain a veneer in the form of a sheet,
(iv) drying said veneer obtained in step (iii) until the moisture content is below the fiber saturation point to obtain a veneer which is composed of slices from board-like, plane pieces of wood wherein said slices are jointly adhered by means of said adhesive,
(v) treating the front and back surfaces and the thickness of said wood sheet of step (iv) with a nanofluid comprising nanoparticles, wherein said nanofluid soaks said wood sheet.

It is also conceivable to employ in the process of the invention also wooden material having a greater thickness dimension than the wood sheet or the veneer according to the invention. Thus, it is conceivable that also lumber, i.e. pieces or boards of wood, having a thickness of more than 10 mm, can be treated according to the process of the invention with the result of lumber having a front and a back surface and a thickness comprising nanoparticles, wherein said nanoparticles are present on said front and back surfaces and throughout the thickness.

It is also conceivable that still thicker lumber, e.g. pieces or boards of wood having a thickness of e.g. 40 or 50 mm or more, may also be treated according to the process of the invention. Herein, it is conceivable that it is not necessary that nanoparticles are present throughout the whole thickness dimension, but only in a portion of the thickness. It is conceivable that a depth of penetration from both the front and the back surface into the thickness dimension of e.g. 10 mm or 15 mm, respectively, is sufficient to impart the advantageous addressed characteristics to said lumber.

The person skilled in the art will readily appreciate that the characteristics of a wood sheet having a front surface, a back surface and a thickness comprising nanoparticles, characterized in that said nanoparticles are present on said front surface, said back surface and throughout the thickness, so as to confer enhanced mechanical or physical or chemical or biological resistance, or combinations of said resistances, to said wood sheet compared to an otherwise similar wood sheet that has no nanoparticles on its front and back surfaces and throughout its thickness, can be determined by sensoric means, in particular by optic and haptic inspection.

Water repellence can also be ascertained by the measurement of the wood moisture content or by the measurement of a water's drop contact angle on the wooden surface. These methods are well known in the art.

The following non-limiting examples describe specific processes and compositions for preparing the wood sheet of the invention.

### EXAMPLES

### Example 1

### Preparation of a Nanofluid in a Two-Step Process using Commercially Available Starting Materials

Step 1: Preparation of nanoparticles

200 g nanosized silica powder, 20 g fluorocarbon surfactant and 50 g 3-aminopropyltriethoxysilane are mixed in 200 toluene and are stirred for 5 h at room temperature. Subsequently, toluene is removed by evaporation. The resulting product is dried at 120° C. for 2 h and subsequently dispersed with air-flow crusher to obtain white powdered nanosized modified material.

Step 2: Preparation of a nanofluid

100 g of the nanoparticles of step 1 are dispersed in a mixture of 860 g distilled water, 20 g polyvinylalcohol and 20 g n-butanol using Ultra Turrax® equipment to obtain a nanofluid having the above produced nanoparticles dispersed therein.

### Example 2

### Soaking a Wood Veneer with the Nanofluid of Example 1

A veneer made from sapele wood and having a length and a width of approximately 50 cm and a thickness of 1 mm is completely dunked into the nanofluid of Example 1. After 30 min, the veneer is removed and is dried at 100° C. for 5 min.

The veneer has the same appearance and feel of the otherwise similar wood sheet that has no nanoparticles on its front and back surfaces and throughout its thickness.

### Example 3

### Comparison of the Water Repellence of the Veneer Soaked with the Nanofluid According to Example 2 with the Corresponding Veneer that is not Soaked with the Nanofluid

The veneer of Example 2 and the corresponding veneer that is not soaked with the nanofluid are dunked into water. After 30 seconds, the veneers are removed from the water. The water repellence is compared by sensoric methods, i.e. by optic and haptic inspection. The surface of the veneer according to the invention is still dry as can be seen and felt; water drops roll off the surfaces of said veneer. The veneer not being treated with the nanofluid is wet throughout the whole thickness due to absorbed water.

What is claimed:

1. A wood sheet comprising: a front surface, a back surface and a thickness comprising nanoparticles, said nanoparticles are present on said front surface, said back surface and throughout the thickness.

2. The wood sheet according to claim 1, wherein the sheet is a veneer.

3. The wood sheet according to claim 1, wherein the thickness is from 0.1 to 10 mm, preferably from 0.2 to 6 mm, more preferred from 0.5 to 3 mm.

4. The wood sheet according to claim 1, wherein the average particle size of said nanoparticles is less than 100 nm, preferably less than 50 nm, more preferred less than 30 nm.

5. The wood sheet according to claim 1, wherein the quantity of said nanoparticles is from 0.5 g nanoparticles/m² wood sheet to 20 g nanoparticles/m² wood sheet, preferably from 1 g/m² to 15 g/m², more preferred from 2 g/m² to 10 g/m².

6. A process for the manufacture of a wood sheet according to claim 1, the process comprising: treating the front and back surfaces and the thickness of a wood sheet with a nanofluid comprising nanoparticles, wherein said nanofluid soaks said wood sheet.

7. The process according to claim 6, wherein the treating is one or more processes selected from the group consisting of: spraying process, brushing process, dunking process, application process by means of rollers, application by means of pressure.

8. The process according to claim 6, comprising one or more further steps selected from the group consisting of: drying process, grinding process, polishing process, cutting process, gluing process, varnishing process, application of a fungicide, or combinations of said processes.

9. The process according to claim 6, wherein the moisture content of said wood sheet prior to the treating is below the fiber saturation point.

10. The wood product comprising: one of a wood sheet having a front surface, a back surface and a thickness comprising nanoparticies, said nanoparticles are present on said front surface, said back surface and throughout the thickness and a wood sheet manufactured according to claim 6, and a substrate.

11. The wood product of claim 10, wherein said substrate is selected from the group consisting of wood, plywood, laminated fiber sheet, plastic, metal, stone.

12. The process for the manufacture of a wood product according to claim 10, wherein said wood sheet is glued onto said substrate.

13. Use of a wood sheet as defined in claim 1 for the equipment of bath rooms, wellness installations, clinical practice equipments, equipment in yachting, equipment for restaurants.

14. The use according to claim 13, wherein the equipment of bath rooms is selected from the group consisting of walls, floors, wash basins, showers, bathtubs; the wellness installations are selected from the group consisting of swimming pools and saunas; the clinical practice equipments are selected from all surfaces to be easily and hygienically cleaned; the equipment for yachting is selected from the group consisting of decks and body fairing; the equipment for restaurants is selected from the group consisting of tables and bars.

15. Use of a wood sheet manufactured according to claim 6, for the equipment of bath rooms, wellness installations, clinical practice equipments, equipment in yachting, equipment for restaurants.

16. Use of a wood product as defined in claim 10 for the equipment of bath rooms, wellness installations, clinical practice equipments, equipment in yachting, equipment for restaurants.

17. Use of a wood product manufactured according to claim 12 for the equipment of bath rooms, wellness installations, clinical practice equipments, equipment in yachting, equipment for restaurants.

18. A wood sheet having a front surface, a back surface and a thickness comprising nanoparticles, characterized in that said nanoparticles are present on said front surface, said back surface and throughout the thickness, said wood sheet being obtainable by a process comprising steps (i) to (v):
(i) gluing board-like, plane pieces of wood holohedrally by means of an adhesive to a beam-like block of wood,
(ii) watering said beam-like block of wood obtained in step (i),
(iii) cutting said beam-like block of wood obtained in step (ii) such that the section plane is transversely arranged to the plane which is defined by the adhesion layers in said block to obtain a veneer in the form of a sheet,
(iv) drying said veneer obtained in step (iii) until the moisture content is below the fiber saturation point to obtain a veneer which is composed of slices from board-like, plane pieces of wood wherein said slices are jointly adhered by means of said adhesive,
(v) treating the front and back surfaces and the thickness of said wood sheet of step (iv) with a nanofluid comprising nanoparticles, wherein said nanofluid soaks said wood sheet.
